(19) United States
(12) Patent Application Publication
(10) Pub. No.: US 2025/0341487 A1
(43) Pub. Date: Nov. 6, 2025

(54) CAPACITANCE SENSOR FOR ENVIRONMENTAL DETECTION DEVICE

(71) Applicant: Microchip Technology Incorporated, Chandler, AZ (US)

(72) Inventors: Arthur B. Eck, Gilbert, AZ (US); Patrick McFarland, Gilbert, AZ (US)

(73) Assignee: Microchip Technology Incorporated, Chandler, AZ (US)

(21) Appl. No.: 18/953,161

(22) Filed: Nov. 20, 2024

Related U.S. Application Data
(60) Provisional application No. 63/641,816, filed on May 2, 2024.

(51) Int. Cl. G01N 27/22; G08B 29/26

(52) U.S. Cl. CPC G01N 27/228; G01N 27/221; G01N 27/223; G01N 27/226; G08B 29/26; G01N 2027/222

(57) ABSTRACT

An environmental detection device including a housing, a capacitance detection circuit comprising a capacitor within the housing, and a chamber within the housing. The chamber including an air inlet to allow air to pass through the housing into the chamber and an environmental sensor to detect an environmental characteristic. The device including a first mesh structure at least partially covering the air inlet of the chamber, a first metallic conductor comprising at least a first portion of the first mesh structure, a second metallic conductor separated from the first metallic conductor by at least one dielectric material, a first electrical connection from the first metallic conductor to the relaxation oscillator circuit, and a second electrical connection from the second metallic conductor to a ground, wherein the first metallic conductor and the second metallic conductor form the capacitor of the relaxation oscillator circuit.

### PRIORITY STATEMENT

This application claims priority to U.S. Provisional Patent Application No. 63/641,816 filed May 2, 2024, the contents of which are hereby incorporated in their entirety.

### TECHNICAL FIELD

The present disclosure relates to capacitance sensors for environmental detection devices, e.g., life safety devices.

### BACKGROUND

Environmental detection devices rely on various sensors to detect environmental conditions. Examples of environmental detection devices may include life safety devices, such as smoke detectors and carbon monoxide detectors, without limitation, that rely on various sensors to detect different types of hazardous conditions within an environment. For example, some smoke detectors include a photoelectric detector, an ionization detector, or a combination of both. In a photoelectric smoke detector, an alarm may be triggered when smoke detected based upon the amount of light detected from a light source onto a light sensor. In an ionization smoke detector, ionized air molecules attach to the smoke particles that enter the chamber, changing the ionizing current, which may result in an alarm being triggered based on the change in the ionizing current.

In general, the ionization detector reacts faster than the photoelectric detector in responding to flaming fires, and the photoelectric detector is more responsive to smoldering fires. Because an ion detector tests the air for small combustible particles, it can be fooled by chemical or paint particles in the atmosphere. The photoelectric detector, which “sees” the smoke from the fire, can be fooled by objects, dust, humidity, or even insects. Though both offer protection against undetected fires, ionization detectors experience a higher incidence of nuisance alarms.

Photoelectric smoke detectors, also referred to as optical beam smoke detectors, work on the principle of light obscuration, where the presence of smoke blocks some of the light from the light source beam from reaching the light sensor. Once a certain percentage of the transmitted light has been blocked by the smoke, a fire alarm may be triggered. Photoelectric smoke detectors may be used to detect fires in large commercial and industrial buildings, as components in a larger fire alarm system.

Photoelectric smoke detectors consist of at least one light transmitter and one light sensor to receive the transmitted light. The photosensitive receiver monitors light produced by the transmitter under normal conditions. In the absence of smoke, light passes from the light transmitter to the receiver in a straight line. In a fire, when smoke falls within the path of the beam detector, some of the light is absorbed or scattered by the smoke particles. This creates a decrease in the received light signal from the light sensor, leading to an increase in optical obscuration, which is a reduction of transmittance of light across the beam path.

In some circumstances, false alarms may be triggered, e.g., by increased noise in the signals from sensors. For example, if objects or insects infiltrate the photo chamber of a photoelectric detector or ionization chamber of an ionization detector, they may create noise that results in a false alarm. Another example is humidity. Increased humidity in the environment around the sensor, and thus in the smoke detection chamber of a smoke detector, can create signal noise that may trigger false alarms.

One approach to address noise and false alarms caused by humidity, for example, is to use multiple light sources such as LEDs with different wavelengths in the photo chamber. This may allow for greater discrimination of different particles in the air at the expense of increased cost, increased power consumption, increased chamber size, and increased issues with light leakage, and manufacturability. Another approach is to combine a photo chamber with an ionization chamber to cover a wider range of particles that can be detected. The disadvantages of this include again the increased power consumption, the use of a higher voltage source for the ion chamber, and increased manufacturing complexity. Another approach is to use a heat detector either alone or together with a photo chamber to measure both rate-of-rise of temperature as well as particles in the air for the detection of fires. Heat detectors use relatively large amounts of power and represent an added cost and board footprint.

### SUMMARY

According to an aspect, there is provided an apparatus, including a housing, a capacitance detection circuit comprising a capacitor within the housing, and a chamber within the housing. The chamber includes an air inlet to allow air to pass through the housing into the chamber, and an environmental sensor to detect an environmental characteristic. The apparatus including a first mesh structure at least partially covering the air inlet of the chamber, a first metallic conductor comprising at least a first portion of the first mesh structure, a second metallic conductor separated from the first metallic conductor by at least one dielectric material, a first electrical connection from the first metallic conductor to the capacitance detection circuit, and a second electrical connection from the second metallic conductor to a ground, wherein the first metallic conductor and the second metallic conductor form the capacitor of the capacitance detection circuit.

An aspect according to the apparatus of the preceding paragraph, wherein the capacitance detection circuit comprises a relaxation oscillator circuit to provide a frequency output that corresponds to a cyclic charging and discharging of the capacitor. An aspect wherein the relaxation oscillator circuit comprises a Schmitt trigger and an analog-to-digital converter.

Aspects according to the apparatus of one of the preceding two paragraphs may also include the following. An aspect wherein the capacitance detection circuit comprises a relaxation oscillator circuit and the at least one dielectric material comprises air from the air inlet. An aspect wherein a frequency output of the relaxation oscillator circuit corresponds to a humidity level of the air from the air inlet. An aspect including a logic circuit for a life safety device, the logic circuit to adjust an alarm limit for the life safety device based on the frequency output of the relaxation oscillator circuit to account for a change in the humidity level of the air from the air inlet. An aspect wherein the second metallic conductor is formed from a second portion of the first mesh structure electrically insulated from the first portion of the first mesh structure. An aspect including a second mesh structure disposed within the first mesh structure, wherein the second mesh structure is electrically insulated from the first mesh structure, and the second metallic conductor comprises at least a portion of the second mesh structure. An aspect wherein the first metallic conductor comprises substantially all of the first mesh structure, and the second metallic conductor comprises substantially all of the second mesh structure. An aspect including a plurality of insulating spacers to maintain a distance between the first mesh structure and the second mesh structure.

Aspects according to the apparatus of one of the preceding three paragraphs wherein the second metallic conductor comprises a metallic plate or a metallic foil within the housing. An aspect wherein the chamber has an interior surface and an exterior surface, and the second metallic conductor comprises a metallic foil applied to the exterior surface of the chamber.

According to an aspect, there is provided an apparatus, including a power circuit to receive power from a power supply of a life safety device, a relaxation oscillator circuit powered by the power circuit, the relaxation oscillator circuit comprising a capacitor formed from at least a portion of a structural element of the life safety device, and a logic circuit powered by the power circuit. The logic circuit to receive a signal from the relaxation oscillator circuit indicating a frequency corresponding to cyclic charging and discharging of the capacitor and correlate the received signal to a characteristic of air in proximity to the life safety device.

Aspects according to the apparatus of the preceding paragraph may also include the following. An aspect wherein the characteristic of air is a humidity level, and the logic circuit to adjust an alarm limit of the life safety device based on the humidity level to reduce an occurrence of false alarms due to humidity. An aspect wherein the structural element comprises a metallic mesh structure positioned around an air inlet to an environmental sensing chamber of the life safety device. An aspect wherein the relaxation oscillator circuit comprises a Schmitt trigger and an analog-to-digital converter.

According to an aspect, there is provided a method, including cyclically charging and discharging a capacitor, wherein the capacitor comprises a first metallic conductor and a second metallic conductor separated by at least one dielectric material, the capacitor forms part of a relaxation oscillator circuit, and the first metallic conductor forms at least part of a first structural element of a life safety device. The method including receiving a signal by a logic circuit of the life safety device from the relaxation oscillator circuit, determining a frequency of the relaxation oscillator circuit based on the received signal and correlating the frequency to a characteristic of air in proximity to the life safety device.

An aspect according to the method of the preceding paragraph, including adjusting an alarm limit of the life safety device, wherein the characteristic of air is a humidity level, and the alarm limit is adjusted based on the humidity level to reduce an occurrence of false alarms due to humidity. An aspect including establishing a baseline frequency for an ambient humidity level of air in proximity to the life safety device. An aspect wherein the first structural element comprises a metallic mesh structure positioned around an air inlet to an environmental sensing chamber of the life safety device.

### BRIEF DESCRIPTION OF THE DRAWINGS

The figures illustrate aspects of capacitance sensors for environmental detection devices in accordance with the present disclosure.

FIG. 1 illustrates a side view of an environmental condition detection device including a light source and sensor to emit and detect light.

FIG. 2A and 2B illustrate side and top views of an environmental condition detection device, respectively, including a light source and sensor to emit and detect light.

FIG. 3A illustrates a top view of an environmental condition detection device including a light source and sensor to emit and detect light.

FIG. 3B illustrates a block diagram of an environmental condition detection device including a light source and sensor to emit and detect light.

FIG. 3C provides an illustration of a metallic mesh structural component or screen 382 of an environmental detection device.

FIG. 4 illustrates a capacitance sensor for an environmental detection device.

FIG. 5 illustrates a capacitance sensor for an environmental detection device.

FIG. 6 illustrates a capacitance sensor for an environmental detection device.

FIG. 7 illustrates an environmental detection device including a capacitance sensor.

FIG. 8 illustrates a method of operation for an environmental detection device including a capacitance sensor.

FIG. 9 illustrates an environmental detection device including a capacitance sensor.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

Environmental detection devices rely on various sensors to detect environmental characteristics that may indicate certain environmental conditions. For example, life safety devices, such as smoke detectors, rely on various sensors to detect different types of environmental characteristics, e.g., an amount of light reflected or obscured by smoke particles in the air and to indicate the presence of an environmental condition, e.g., a hazardous condition such as the presence of smoke or fire in the environment around the life safety device. Adding additional discrete sensors results in increased cost, use of space within the device, and power consumption. Companies seek to balance the various features, a sensor's ability to detect certain hazards, and the resulting costs. This can be seen in the case of smoke detectors that also include carbon monoxide detection, which requires additional components, testing and certifications in addition to the smoke detection sensors. By utilizing structural components found in a smoke detector to act as an additional sensor, cost, board space, and the ability to better detect hazards could be improved. Aspects of the present disclosure include utilizing metallic structural components of an environmental detection device, such as a life safety device, without limitation, to form at least part of a capacitor. The capacitor may serve as an additional sensor for the environmental detection device and may be used to detect changes in certain characteristics of the environment. For example, the capacitor may be used to detect changes in the humidity of the air surrounding the environmental detection device. In other examples, the capacitor may be used to detect changes in gas composition or particulate concentration, without limitation, in the environment based on changes to capacitance or permittivity of the dielectric material separating portions of the capacitor. Examples of environmental detection devices may include smoke detectors, carbon monoxide detectors, temperature sensors, toxic gas detectors, and detectors for other airborne particulates, without limitation. Although reference is made herein to smoke detectors by way of example, the present disclosure is not limited to smoke detectors.

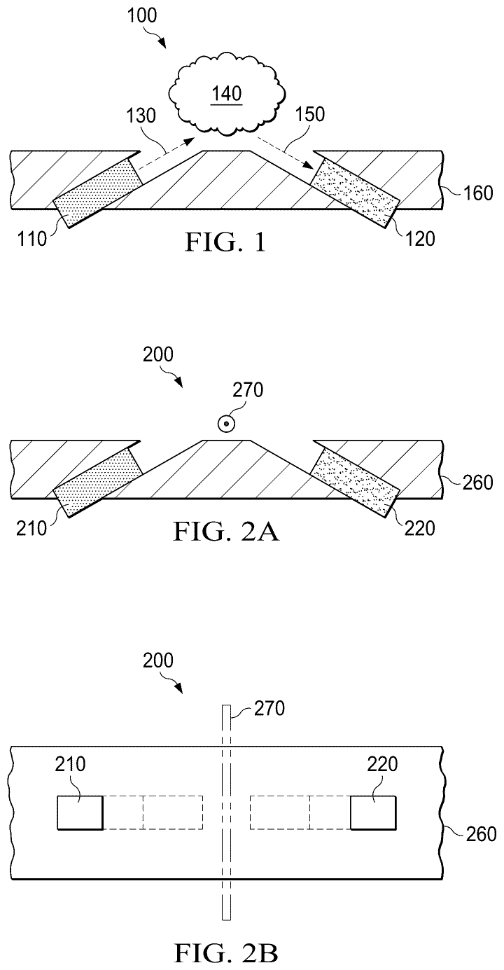

FIG. 1 illustrates a side view of an environmental condition detection device including a light source and sensor to emit and detect light. Environmental condition detection device 100 may include light source 110 and light sensor 120.

Light source 110 may emit light beam 130. Light source 110 may be any suitable type of light source, such as, but not limited to, a light emitting diode (LED), a vertical cavity surface emitting laser, or an incandescent light bulb. Light beam 130 may be formed of infrared, visible, or ultraviolet light. When smoke is present, light beam 130 may reflect off smoke particles 140, resulting in reflected light beam 150. Reflected light beam 150 may be received by light sensor 120. Light sensor 120 may be any suitable type of light sensor, such as, but not limited to, a photodiode or a phototransistor. In some examples, light sensor 120 may include multiple light sensors. When reflected light beam 150 is received by light sensor 120, light sensor 120 may generate an electrical signal that may be analyzed to determine when to sound a fire alarm or to determine smoke density or concentration.

Light source 110 and light sensor 120 may be mounted in carrier 160. Carrier 160 may provide connections between light source 110, light sensor 120, and other circuits in photoelectric smoke detector 100, such as, but not limited to, a control circuit, alarm circuit, and power supply. Light source 110 and light sensor 120 may be spaced apart from each other such that light sensor 120 does not receive light beam 130 directly.

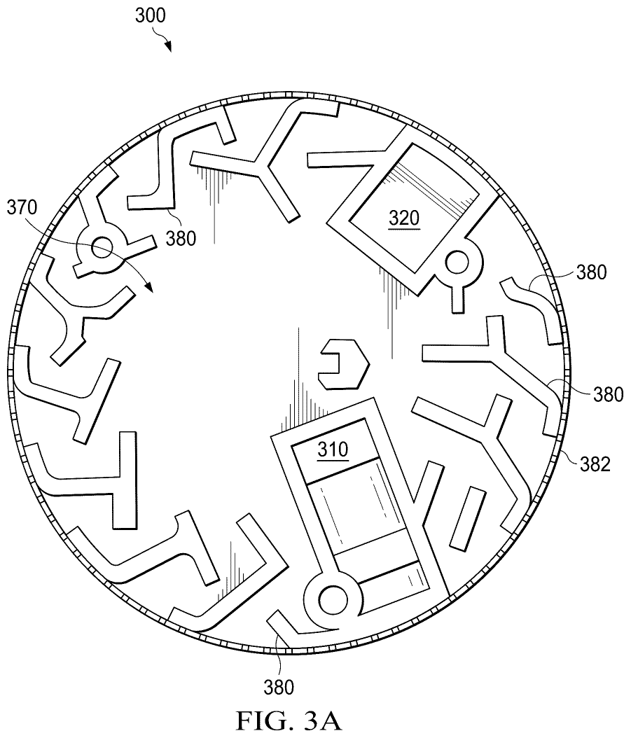

FIGS. 2A and 2B illustrate side and top views of an environmental condition detection device, respectively including a light source and sensor to emit and detect light. Light source 210, light sensor 220, and carrier 260 may be similar to light source 110, light sensor 120, and carrier 160, respectively, shown in FIG. 1. When light source 210 emits a light beam, such as light beam 130, the reflected light beam, such as reflected light beam 150, is reflected about axis of reflection 270.

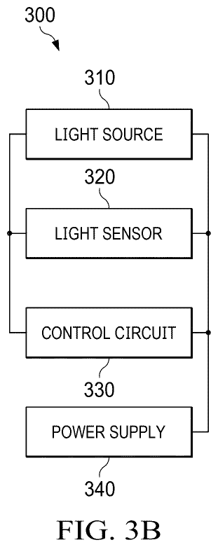

FIG. 3A illustrates a top view of an environmental condition detection device including a light source and sensor to emit and detect light. Environmental condition detection device 300 may include light source 310 and light sensor 320 housed in condition detection chamber 370 defined at the periphery by a screen 382 and surrounded by baffles 380 within the screen 382.

Light source 310 may be similar to light source 110 shown in FIG. 1 and light sensor 320 may be similar to light sensor 120 shown in FIG. 1. Light source 310 and light sensor 320 may be used to detect the presence of smoke particles within condition detection chamber 370.

Baffles 380 may be arranged along the outer perimeter of condition detection chamber 370. Baffles 380 may allow smoke to enter condition detection chamber 370 and may reduce the amount of extraneous light entering condition detection chamber 370. If extraneous light enters the chamber, the extraneous light may be detected by light sensor 320, causing the smoke detector to incorrectly identify the presence of smoke particles. Extraneous light entering condition detection chamber 370 (referred to as “baffle reflection leakage light”) may be light reflected off baffles 380.

FIG. 3B illustrates a block diagram of an environmental condition detection device including a light source and sensor to emit and detect light. Environmental condition detection device 300 may include light source 310, light sensor 320, control circuit 330, and power supply 340.

Light source 310 may be similar to light source 110, or light source 210, or light source 310 described with respect to FIGS. 1, 2, and 3A, respectively. Light source 310 may emit a light beam based on a command from control circuit 330. Light source 310 may be any suitable type of light source, such as, but not limited to, a light emitting diode (LED), a vertical cavity surface emitting laser, or an incandescent light bulb.

Light sensor 320 may be similar to light sensor 120, light sensor 220, or light sensor 320 described with respect to FIGS. 1, 2, and 3A, respectively. Light sensor 320 may be any suitable type of light sensor, such as, but not limited to, a photodiode or a phototransistor. In some examples, light sensor 320 may include multiple light sensors. When a reflected light beam is received by light sensor 320, light sensor 320 may generate an electrical signal that may be transmitted to control circuit 330 for processing and analysis to determine when to sound a fire alarm.

Control circuit 330 may receive the electrical signal from light sensor 320 and process and analyze the signal. Control circuit 330 may, when the electrical signal from light sensor 320 exceeds a threshold, sound an alarm indicating the presence of smoke in the vicinity of environmental condition detection device 300. Control circuit 330 may include a central processing unit (CPU), a general purpose processor, a specific purpose processor, a microcontroller, a programmable logic controller (PLC), a digital signal processor (DSP), an analog front-end (AFE), an application specific integrated circuit (ASIC), a field-programmable gate array (FPGA) or other programmable logic device, discrete gate or transistor logic, discrete hardware components, other programmable device, or any combination thereof.

Power supply 340 may power the components of environmental condition detection device 300 including light source 310, light sensor 320, and control circuit 330.

FIG. 3C provides an illustration of a metallic mesh structural component or screen 382 of an environmental detection device. Metallic mesh structural component or screen 382 may include a plurality of perforations. Metallic mesh structural component or screen 382 may be cylindrical in shape, as shown, cubic in shape, or any other suitable geometry to at least partially cover an air inlet of an environmental sensing chamber, e.g., the air inlet for photo chamber 370 (see FIG. 3A). Metallic mesh structural component or screen 382 may be used to prevent relatively large objects and insects from getting inside the life safety device and interfering with the operation of the sensors housed within the environmental detection device. Metallic mesh structural component or screen 382 may be used to form at least part of a capacitive sensor within the life safety device that may be used to detect changes in a characteristic of the environment around the life safety device, e.g., the humidity of surrounding air, without limitation. The capacitance of this metal mesh, either between physically separate portions of the metal mesh or between other metallic elements within the life safety device can be measured and change based on the difference in capacitance or permittivity between environmental conditions, e.g., based on a change in humidity, a change in the composition of gases in the environment, or a presence of particulate matter, without limitation. Utilizing metallic mesh structural component or screen 382 to form at least part of capacitor would allow for a low-cost additional sensor using components already found in the environmental detection device. The addition of a low-cost sensor capable of detecting environmental variables like gas composition, particulate concentration, and humidity, without limitation, and will help improve the discrimination of environmental conditions, such as a fire or other hazardous condition, and improve resilience against noise, such as that caused by changes in humidity. This solution requires few additional manufacturing steps at minimal cost while simultaneously providing a new sensor. This sensor has the advantage of being sensitive to humidity which is a common source of noise for life safety devices and can allow the troubleshooting of humidity related issues that may otherwise appear to be a fire in the example of a smoke detector. In addition, it can be used to provide an alert to users about humidity, gas concentrations, or airborne particulate matter levels. The use of measuring changes in capacitance to detect environmental characteristics such as humidity is described in U.S. Pat. Nos. 8,884,771 and 9,823,280, both of which are incorporated herein by reference in their entirety and for all purposes.

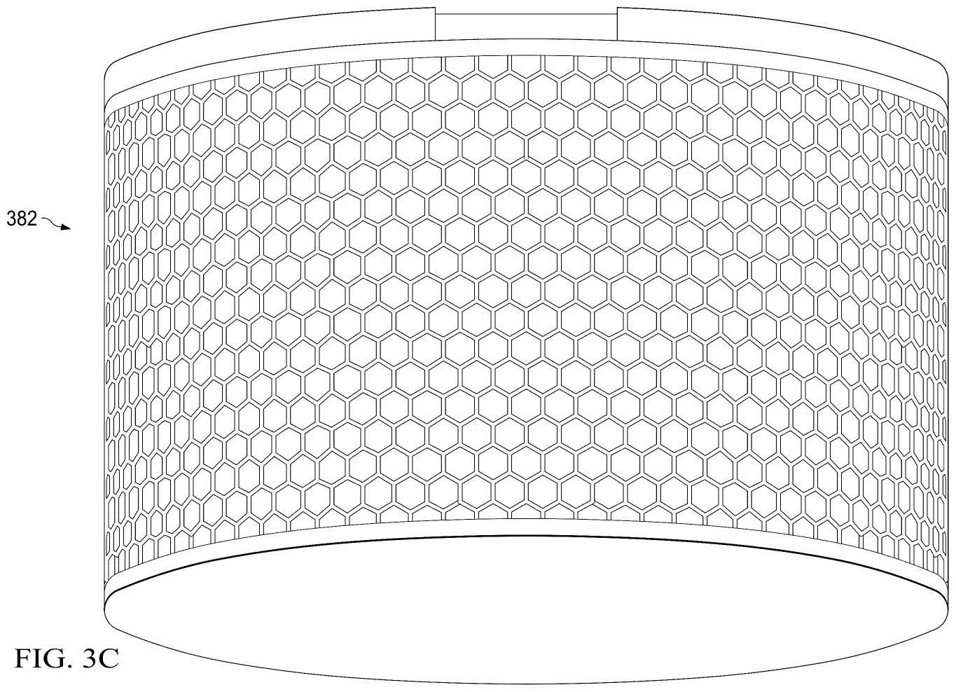

FIG. 4 provides an illustration of capacitive sensor 400. Capacitive sensor 400 may include a capacitor 410 and a capacitance detection circuit 450. In some examples, capacitor 410 may be a metal mesh structural component and may include two physically separate portions 411 and 412. Capacitor 410 may be electrically coupled to capacitance detection circuit 450 via electrical connections 421 and 422. In some examples, one of the electrical connections 421 or 422 may be electrically coupled to a ground. In this manner, capacitor 410 may be formed by the two physically separate halves (portions 411 and 412) of a metal mesh structural component. Capacitive detection circuit 450 may be used to measure capacitance between portions 411 and 412, where the air in between portions 411 and 412 serves as the dielectric material. The capacitance measured by capacitance detection circuit 450 may vary based on environmental factors such as humidity of the air between portions 411 and 412. Other environmental factors may include gas composition and particulate concentration, without limitation. In some examples, capacitance detection circuit 450 may include or be part of a relaxation oscillator circuit to measure the change in frequency that occurs as a result of a change in capacitance. In some examples, capacitance detection circuit 450 may include an inverting Schmitt trigger and an analog to digital converter (ADC). In some examples, capacitance detection circuit 450 may be implemented other ways to detect a shift in capacitance. For example, capacitance detection circuit 450 may be implemented as a resistor-capacitor circuit to detect changes in the time constant due to changes in capacitance or permittivity. As another example, capacitance detection circuit 450 may be implemented as a resistor-capacitance divider circuit to detect changes in the capacitance divider imbalance due to changes in capacitance or permittivity. In some examples, capacitance detection circuit 450 may include logic circuit 460. In some examples, capacitance detection circuit 450 may be integrated with logic circuit 460 as indicated by the dashed line 465. Logic circuit 460 may be implemented in any suitable manner, such as by an application specific integrated circuit (ASIC), field programmable gate array (FPGA), programmable logic device (PLD), reprogrammable logic or hardware, analog circuitry, digital circuitry, digital logic, microcontroller, or instructions for execution by a processor, or any suitable combination thereof. In some examples, logic circuit 460 may include pins that can operate as an inverting Schmitt trigger and may include an on-chip ADC. This would allow for a capacitive sensor 400 that uses a few traces, such as connections 421 and 422, which may be electrically coupled to portions 411 and 412 (e.g., by soldering or brazing, without limitation), respectively, and to capacitance detection circuit 450, reducing cost and improving manufacturability.

This solution requires very few additional manufacturing steps at minimal cost while simultaneously providing a complete new sensor, such as capacitive sensor 400. This sensor has the advantage of being sensitive to humidity which is a common source of noise for life safety devices and can allow the troubleshooting of humidity related issues that would otherwise appear to be a fire in the instance of a smoke detector. In addition, it can be used to provide an alert to users about humidity, changes in gas composition, or airborne particulate matter levels.

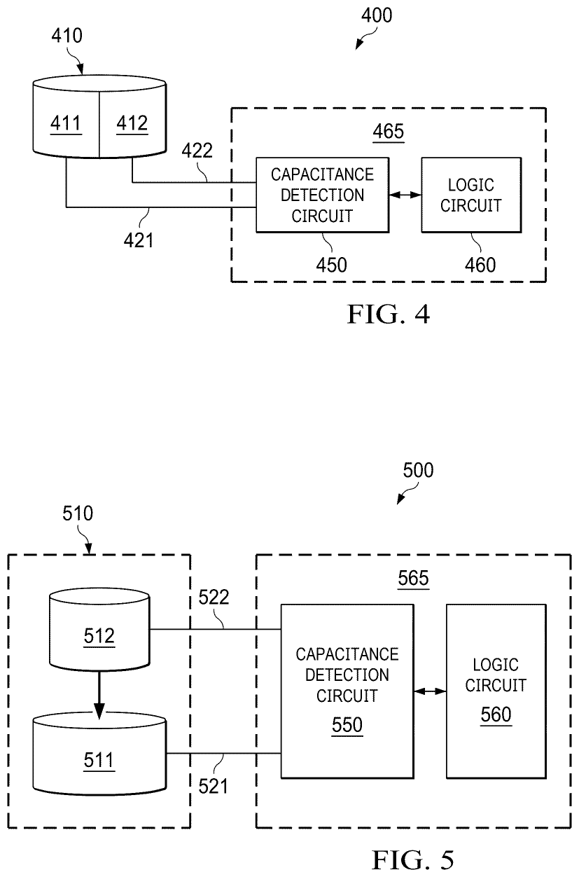

FIG. 5 provides an illustration of capacitive sensor 500. Capacitive sensor 500 may include a capacitor 510 and a capacitance detection circuit 550. Capacitor 510 may include two physically separate metal mesh structural components 511 and 512. Metal mesh structural components 511 and 512 may be differently sized such that component 512 sits inside of component 511. In some examples, capacitor 510 may be within a chamber of an environmental detection device with a very small distance of separation from one another. In this way, capacitor 510 may allow for a larger capacitance value and potentially increased sensitivity to various environmental conditions compared to other examples disclosed herein. Capacitor 510 may be electrically coupled to capacitance detection circuit 550 via electrical connections 521 and 522. In some examples, one of the electrical connections 521 or 522 may be electrically coupled to a ground. In this manner, capacitor 510 may be formed by the two physically separate metal mesh structural components 511 and 512, one nested inside the other. Capacitive detection circuit 550 may be used to measure capacitance between portions 511 and 512, where the air in between portions 511 and 512 serves as the dielectric material. The capacitance measured by capacitance detection circuit 550 may vary based on environmental factors such as humidity of the air between portions 511 and 512. Other environmental factors may include gas composition and particulate concentration, without limitation. In some examples, capacitance detection circuit 550 may be implemented in the same manner as capacitance detection circuit 450 described above. In some examples, capacitance detection circuit 550 may include logic circuit 560. In some examples, capacitance detection circuit 550 may be integrated with logic circuit 560 as indicated by the dashed line 565. In some examples, capacitance detection circuit 550 and logic circuit 560 may be implemented in the same manner as capacitance detection circuit 450 and logic circuit 460 described above.

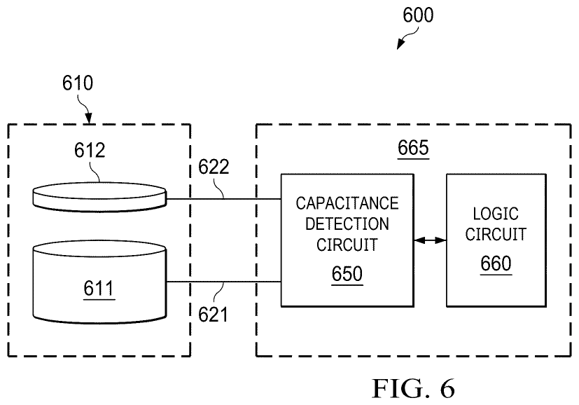

FIG. 6 provides an illustration of capacitive sensor 600. Capacitive sensor 600 may include a capacitor 610 and a capacitance detection circuit 650. Capacitor 610 may include a metal mesh structural component 611 and a physically separate metallic conductor 612. Metallic conductor 612 may be a disc, a plate, foil, or a metallic coating. In some examples, metallic conductor 612 may be within the housing of an environmental detection device such as a smoke detector, without limitation. In some examples, metallic conductor 612 may include a metallic foil applied to an interior or exterior surface of a chamber within an environmental detection device, e.g., to the surface of a photo chamber or ionization chamber, without limitation. For example, a foil-type metallic conductor 612 may be applied to the exterior surface of a photo chamber. In these ways, metallic conductor 612 may act as an additional metallic surface to form capacitor 610 with the metal mesh structural component 611. Capacitor 610 may be electrically coupled to capacitance detection circuit 650 via electrical connections 621 and 622. In some examples, one of the electrical connections 621 or 622 may be electrically coupled to a ground. Capacitive detection circuit 650 may be used to measure capacitance between metal mesh structural component 611 and metallic conductor 612, where the air in between them serves as the dielectric material. The capacitance measured by capacitance detection circuit 650 may vary based on environmental factors such as humidity of the air between portions 611 and 612. Other environmental factors may include gas composition and particulate concentration, without limitation. In some examples, where metallic conductor 612 is applied to the exterior of a chamber, the chamber material will also impact capacitance, however, the dielectric properties of the chamber are not expected to change with environmental factors in the same way that air in the environment will. Thus, changes in capacitance can still be correlated to changes in the dielectric constant of the air separating portions 611 and 612. In some examples, capacitance detection circuit 650 may be implemented in the same manner as capacitance detection circuits 450 and 550 described above. In some examples, capacitance detection circuit 650 may include logic circuit 660. In some examples, capacitance detection circuit 650 may be integrated with logic circuit 660 as indicated by the dashed line 665. In some examples, capacitance detection circuit 650 and logic circuit 660 may be implemented in the same manner as capacitance detection circuits 450 and 550 and logic circuits 460 and 560 described above.

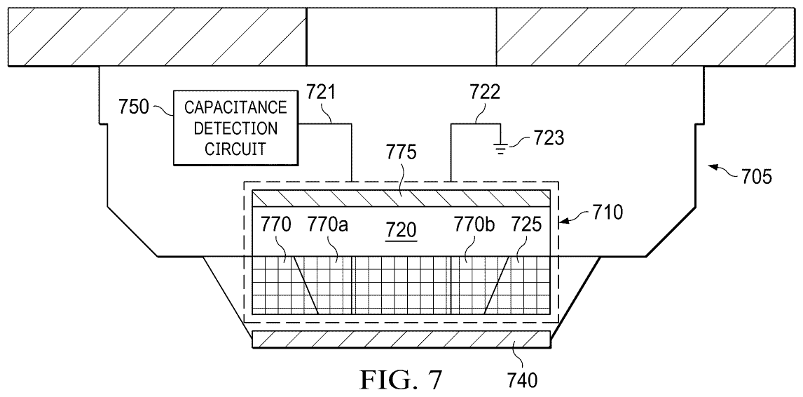

FIG. 7 provides an illustration of an environmental detection device 700 in accordance with the present disclosure. Environmental detection device 700 may include a housing 705. Chamber 720 may be disposed within housing 705. Chamber 720 may be an environmental detection chamber as described in relation to FIG. 1 and FIG. 2 above. Chamber 720 may include environmental sensor 740 to detect an environmental characteristic. In some examples environmental sensor 740 may be implemented similar to light sensor 140 as described in relation to FIG. 1 and FIG. 2 above. In some examples, environmental sensor 740 may be an ionization sensor, a temperature sensor, a toxic gas sensor, or an odor sensor, without limitation. Depending on the type of sensor used, environmental sensor 740 may be located at different places within or on environmental detection device 700. Examples of environmental characteristics may include a level of light detected, a level of ionization detected, a temperature detected, a presence of a toxic gas, and an odor, without limitation. Environmental characteristics may be used to detect an environmental condition. Examples of environmental conditions may include hazardous conditions, e.g., smoke, fire, toxic gas, without limitation. Chamber 720 may include air inlet 725 to allow air to pass through housing 705 into chamber 720. Mesh structure 770 may at least partially cover air inlet 725 of chamber 720. In some examples, mesh structure 770 may be implemented similar to metallic mesh structural component 382 as described above with reference to FIG. 3C.

In some examples, capacitance detection circuit 750 may be disposed within housing 705. Capacitance detection circuit 750 may be implemented similar to capacitance detection circuit 450, 550, or 650 as described herein. In some examples, environmental detection device 700 may include a logic circuit (not shown), which may be implemented similar to logic circuit 460, 560, or 660 as described herein. In some examples, capacitance detection circuit 750 may be integrated with a logic circuit as described above with reference to 465, 565, or 665. In some examples, environmental detection device 700 may be a life safety device, e.g., a smoke detector, without limitation. The logic circuit may be configured to adjust an alarm limit for the life safety device based on an output from the capacitance detection circuit. For example, the logic circuit may be configured to adjust an alarm limit based on a frequency output of the capacitance detection circuit, e.g., where the capacitance detection circuit includes a relaxation oscillator circuit. The logic circuit may adjust the alarm limit to account for a change in the humidity level of the air from the air inlet. For example, the logic circuit may increase an alarm threshold value for an environmental characteristic detected by environmental sensor 740. This may reduce occurrences of false alarms due to an environmental characteristic. For example, the environmental characteristic may be humidity, and an alarm threshold for an amount of reflected light detected by a light sensor may be increased based on a change in humidity to allow the life safety device more headroom between ambient conditions and alarm conditions that may indicate the presence of a hazardous condition.

Capacitance detection circuit 750 may include a capacitor 710. The combination of capacitance detection circuit 750 and capacitor 710 may form a capacitance sensor, which may be implemented similar to capacitance sensor 400, 500, or 600, as described herein. Capacitor 710 may include a first metallic conductor and a second metallic conductor separated from each other by at least one dielectric material, e.g., air from air inlet 725. Capacitor 710 may be formed at least partially from structural components of environmental detection device 700, such as part or all of mesh structure 770, as described herein. Capacitor 710 may be implemented similar to capacitor 410, 510, or 610 as described herein. In some examples, the first metallic conductor of capacitor 710 may be electrically coupled to capacitance detection circuit 750, e.g., by electrical connection 721, and the second metallic conductor of capacitor 710 may be electrically connected to a ground 723, e.g., by electrical connection 722. In some examples, electrical connections 721 and 722 may be implemented similar to electrical connections 421 and 422, 521 and 522, or 621 and 622, as described above.

Capacitor 710 may be formed in various ways in accordance with the present disclosure. In some examples, mesh structure 770 may be composed of two portions, 770a and 770b, electrically insulated from each other. Portions 770a and 770b may be implemented similar to portions 411 and 412 described above with references to FIG. 4. In this example, portion 770a may be a first metallic conductor that includes a portion of mesh structure 770 and may be electrically connected to capacitance detection circuit 750 via electrical connection 721. Portion 770b may be a second metallic conductor, which also includes a portion of mesh structure 770 in this example, and may be electrically connected to ground 723 via electrical connection 722. In some examples, ground 723 may be accessed through capacitance detection circuit 750 or another circuit, e.g., a logic circuit or a power circuit, without limitation.

In another example, capacitor 710 may be formed from two different mesh structures with one disposed inside the other and electrically insulated from each other, as described with reference to FIG. 5 above. In this example, mesh structure 770 may be the outer mesh structure (e.g., metal mesh structural component 511) and a second mesh structure (not shown) may be disposed within the first mesh structure 770 (e.g., mesh structural component 512). Mesh structure 770 may be a first metallic conductor and the second mesh structure (not shown) may be a second metallic conductor, wherein the first metallic conductor (mesh structure 770) and the second metallic conductor (not shown) form capacitor 710. In some examples, the first metallic conductor may include substantially all of mesh structure 770 and the second metallic conductor may include substantially all of the second mesh structure (not shown). Larger surface areas for each metallic conductor of capacitor 710 may increase sensitivity of the capacitor to changes in characteristics of the dielectric material, e.g., the humidity of air from air inlet 725. In some examples, insulating spacers may be used to maintain a specific distance between the first metallic conductor and the second metallic conductor. The dielectric properties of the insulating spacers may be less dependent on characteristics of the air from air inlet 725, e.g., particle concentration, gas composition, or humidity, without limitation. In some examples, the dielectric properties of the insulating spacers may be relatively constant. In this way, changes in capacitance can be correlated reliably to changes in characteristics of the air from air inlet 725.

In another example, capacitor 710 may be formed from mesh structure 770 and metallic conductor 775. In this example, mesh structure 770 may be a first metallic conductor and metallic conductor 775 may be a second metallic conductor, wherein the first metallic conductor (mesh structure 770) and the second metallic conductor (metallic conductor 775) form capacitor 710. In some examples, metallic conductor 775 may be implemented similar to metallic conductor 612 as described above with reference to FIG. 6. For example, metallic conductor 775 may be a metallic plate, a metallic coating, or a metallic foil. In some examples, metallic conductor 775 is disposed within housing 705. In some examples, metallic conductor 775 may be located on the interior or the exterior of chamber 720. In some examples, metallic conductor 775 may be a foil applied to an exterior surface of chamber 720. Mesh structure 770 may be a first metallic conductor and metallic conductor 775 may be a second metallic conductor, wherein the first metallic conductor (mesh structure 770) and the second metallic conductor (metallic conductor 775) form capacitor 710.

In some examples, capacitance detection circuit 750 may include a relaxation oscillator circuit to provide a frequency output that corresponds to a cyclic charging and discharging of the capacitor. In some examples, the relaxation oscillator circuit may include a Schmitt trigger and an analog-to-digital converter. In some examples, an output of the capacitance detection circuit may correspond to a characteristic of the dielectric material separating the first and second metallic conductors of the capacitor. For example, a frequency output of a relaxation oscillator circuit may correspond to a humidity level of the air from air inlet 725.

Another example may include routing traces on the PCB near or around the photo chamber to use as a low-cost capacitor in conjunction with the metal mesh structural component. Another example may include using the capacitance between pins that already exist on the board, such as the photo chamber LED pins, header pins, connector pins, or even IC package pins. These components could be used to form a capacitance sensor consistent with the disclosures herein.

Another example relates to life safety devices that use ionization detectors with ionization chambers. These chambers typically have an outer metal shell that acts as a contamination screen, means of blocking radiation from leaving the chamber, and also a voltage divider with which the detector voltage is measured to look for things such as smoke particles. This metal shell may also function as a capacitive sensor consistent with the disclosures herein.

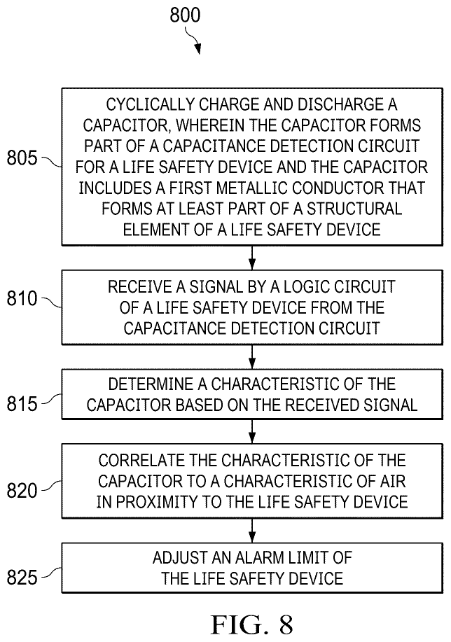

FIG. 8 provides an illustration of an example method 800 of operating an environmental detection device, e.g., a life safety device, in accordance with the present disclosure. Method 800 may be performed by any suitable elements, such as those of the capacitance detection circuits or logic circuits described herein, or combinations thereof, without limitation. Method 800 may be executed with more or fewer steps than shown in FIG. 8, and the steps of method 800 may be optionally omitted, repeated, performed in a different order, performed in parallel, or recursively.

At 805 a capacitor is cyclically charged and discharged. In some examples, the capacitor may include a first metallic conductor and second metallic conductor separated by at least one dielectric material. At least one of the metallic conductors, e.g., the first metallic conductor, may form at least part of a first structural element of a life safety device. For example, the first metallic conductor may form at least part of a metallic mesh structure positioned around an air inlet to an environmental sensing chamber of the life safety device as described herein. The capacitor may form part of a capacitance detection circuit. The capacitor and capacitance detection circuit may be implemented in accordance with the various examples described herein. For example, the capacitor may be implemented similar to capacitor 410, 510, 610, or 710, without limitation. The capacitance detection circuit may be implemented as capacitance detection circuit 450, 550, 650, or 750, without limitation.

At 810, a signal is received by a logic circuit of a life safety device from the capacitance detection circuit. The logic circuit may be implemented in accordance with the various examples disclosed herein. For example, the logic circuit may be implemented similar to logic circuit 460, 560, or 660 without limitation. In some examples, the logic circuit may be combined or integrated with capacitance detection circuit, e.g., as described in relation to 465, 565, or 665.

At 815, a characteristic of the capacitor is determined based on the signal received at 810. In some examples, the capacitance detection circuit may include a relaxation oscillator circuit as described herein. The characteristic of the capacitor may be a frequency indicated by the signal received at 810.

At 820, the characteristic of the capacitor is correlated to a characteristic of air in proximity to the life safety device. For example, the characteristic of air may be a particulate concentration, a gas composition, or a humidity level, without limitation. A characteristic of the air may be correlated with characteristics of the capacitor, and that correlation may be stored, e.g., in a memory for the life safety device or in a database, without limitation. For example, the characteristic of the capacitor may be a frequency indicated by the output of the capacitance detection circuit, which may include a relaxation oscillator circuit as described herein. The characteristic of the air in proximity to the life safety device may be a humidity level. Different frequency values may be correlated to known humidity levels. In some examples, method 800 may also include establishing a baseline frequency for an ambient humidity level of air in proximity to the life safety device. Changes in the frequency indicated by the capacitance detection circuit may be used to determine a change in humidity.

At 825, an alarm limit of the life safety device is adjusted. The alarm limit may be adjusted based on the characteristic of the air in proximity to the life safety device. For example, the alarm limit may be adjusted based on the humidity level of the air to reduce the occurrence of false alarms due to humidity, as described herein. For example, as a humidity level increases, an alarm limit may also be increased to provide more headroom for an environmental sensor between relatively normal conditions and potentially hazardous conditions.

In some examples, data can be collected from the capacitance detection circuit in connection with known characteristics of the air in proximity to an environmental detection device, e.g., a life safety device. For example, capacitance data can be collected for known humidity levels to fingerprint known humidity conditions. The same may be done for other environmental characteristics, such as particulate concentration and gas composition, without limitation. In this way, a database of known environmental characteristics and corresponding capacitance characteristics can be generated and used to determine environmental characteristics based on capacitance characteristics. As one example, a known number of people in a space may be correlated to a capacitance characteristic related to the concentration of carbon dioxide in the air in proximity to an environmental detection device. In this way, an environmental detection device may use the capacitance sensors described herein to determine that a room is or is not occupied by people. As another example, a known concentration of a specific particulate may be correlated to a capacitance characteristic related to the concentration of the particulate in the air in proximity to an environmental detection device. Example particulates may include smoke, dust, coal dust, and flour, without limitation.

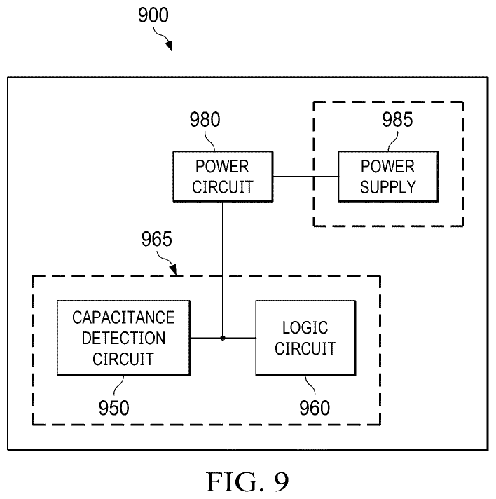

FIG. 9 provides an illustration of an environmental detection device in accordance with the present disclosure. Environmental detection device 900 may be a life safety device, e.g., a smoke detector, a carbon monoxide detector, or similar devices, without limitation. Environmental detection device 900 may include a power circuit 980, capacitance detection circuit 950, and logic circuit 960. Power circuit 980 may receive power from a power supply 985. Power supply 985 may be a power supply for a life safety device. In some examples, power supply 985 may be an internal power supply as shown. In other examples, power supply 985 may be an external power supply as indicated by the dashed line. Capacitance detection circuit 950 may be powered by power circuit 980. Capacitance detection circuit 950 may be implemented as a relaxation oscillator circuit as described herein. Capacitance detection circuit 950 may include a capacitor formed from at least a portion of a structural element of the life safety device in accordance with the various examples disclosed herein. In some examples, the structural element may include at least a portion of a metallic mesh structure positioned around an air inlet to an environmental sensing chamber of the life safety device.

Logic circuit 960 may be powered by power circuit 980. In some examples, logic circuit 960 may be implemented similar to logic circuit 460, 560, or 660, without limitation. In some examples, logic circuit 960 may be combined or integrated with capacitance detection circuit 950 as indicated by dashed line 965 and as described in relation to 465, 565, or 665. Logic circuit 960 may be to: receive a signal from capacitance detection circuit 950 indicating a frequency corresponding to cyclic charging and discharging of the capacitor and correlate the received signal to a characteristic of air in proximity to the life safety device. In some examples, the characteristic of air may be a humidity level. Logic circuit 960 may adjust an alarm limit of the life safety device based on the humidity level to reduce an occurrence of false alarms due to humidity. In some examples, capacitance detection circuit 950 may include a relaxation oscillator circuit. In some examples, the relaxation oscillator circuit may include a Schmitt trigger and an analog-to-digital converter. In some examples, either capacitance detection circuit 950 or logic circuit 960 may receive the digital output from the analog-to-digital converter and determine a frequency, e.g., cycles per second or hertz, based on the number of discharges of the capacitor over a given amount of time.

Although examples have been described above, other variations and examples may be made from this disclosure without departing from the spirit and scope of these disclosed examples.

What is claimed:

1. An apparatus, comprising:
a housing;
a capacitance detection circuit comprising a capacitor within the housing;
a chamber within the housing, the chamber comprising:
an air inlet to allow air to pass through the housing into the chamber;
an environmental sensor to detect an environmental characteristic;
a first mesh structure at least partially covering the air inlet of the chamber;
a first metallic conductor comprising at least a first portion of the first mesh structure;
a second metallic conductor separated from the first metallic conductor by at least one dielectric material;
a first electrical connection from the first metallic conductor to the capacitance detection circuit; and
a second electrical connection from the second metallic conductor to a ground, wherein the first metallic conductor and the second metallic conductor form the capacitor of the capacitance detection circuit.

2. The apparatus of claim 1, wherein the capacitance detection circuit comprises a relaxation oscillator circuit to provide a frequency output that corresponds to a cyclic charging and discharging of the capacitor.

3. The apparatus of claim 2, wherein the relaxation oscillator circuit comprises a Schmitt trigger and an analog-to-digital converter.

4. The apparatus of claim 1, wherein:
the capacitance detection circuit comprises a relaxation oscillator circuit; and
the at least one dielectric material comprises air from the air inlet.

5. The apparatus of claim 4, wherein a frequency output of the relaxation oscillator circuit corresponds to a humidity level of the air from the air inlet.

6. The apparatus of claim 5, comprising a logic circuit for a life safety device, the logic circuit to adjust an alarm limit for the life safety device based on the frequency output of the relaxation oscillator circuit to account for a change in the humidity level of the air from the air inlet.

7. The apparatus of claim 1, wherein the second metallic conductor is formed from a second portion of the first mesh structure electrically insulated from the first portion of the first mesh structure.

8. The apparatus of claim 1, comprising a second mesh structure disposed within the first mesh structure, wherein:
the second mesh structure is electrically insulated from the first mesh structure; and
the second metallic conductor comprises at least a portion of the second mesh structure.

9. The apparatus of claim 8, wherein:
the first metallic conductor comprises substantially all of the first mesh structure; and
the second metallic conductor comprises substantially all of the second mesh structure.

10. The apparatus of claim 8, comprising a plurality of insulating spacers to maintain a distance between the first mesh structure and the second mesh structure.

11. The apparatus of claim 1, wherein the second metallic conductor comprises a metallic plate or a metallic foil within the housing.

12. The apparatus of claim 11, wherein:
the chamber has an interior surface and an exterior surface; and
the second metallic conductor comprises a metallic foil applied to the exterior surface of the chamber.

13. An apparatus, comprising:
a power circuit to receive power from a power supply for a life safety device;
a capacitance detection circuit powered by the power circuit, the capacitance detection circuit comprising a capacitor formed from at least a portion of a structural element of the life safety device;
a logic circuit powered by the power circuit to:
receive a signal from the capacitance detection circuit indicating a frequency corresponding to cyclic charging and discharging of the capacitor; and
correlate the received signal to a characteristic of air in proximity to the life safety device.

14. The apparatus of claim 13, wherein:
the characteristic of air is a humidity level; and
the logic circuit to adjust an alarm limit of the life safety device based on the humidity level to reduce an occurrence of false alarms due to humidity.

15. The apparatus of claim 13, wherein the structural element comprises a metallic mesh structure positioned around an air inlet to an environmental sensing chamber of the life safety device.

16. The apparatus of claim 13, wherein the capacitance detection circuit comprises relaxation oscillator circuit comprising a Schmitt trigger and an analog-to-digital converter.

17. A method comprising:
cyclically charging and discharging a capacitor, wherein:
the capacitor comprises a first metallic conductor and a second metallic conductor separated by at least one dielectric material;
the capacitor forms part of a capacitance detection circuit;
the first metallic conductor forms at least part of a first structural element of a life safety device;
receiving a signal by a logic circuit of the life safety device from the capacitance detection circuit;
determining a characteristic of the capacitor based on the received signal; and
correlating the characteristic of the capacitor to a characteristic of air in proximity to the life safety device.

18. The method of claim 17, comprising adjusting an alarm limit of the life safety device, wherein:
the capacitance detection circuit comprises a relaxation oscillator circuit;
the characteristic of the capacitor is a frequency indicated by the received signal;
the characteristic of air is a humidity level; and
the alarm limit is adjusted based on the humidity level to reduce an occurrence of false alarms due to humidity.

19. The method of claim 18, comprising:
establishing a baseline frequency for an ambient humidity level of air in proximity to the life safety device.

20. The method of claim 17, wherein the first structural element comprises a metallic mesh structure positioned around an air inlet to an environmental sensing chamber of the life safety device.
